(19) United States
(12) Patent Application Publication
(10) Pub. No.: US 2013/0076765 A1
(43) Pub. Date: Mar. 28, 2013

(54) Image Data Displaying System and Method for Displaying Image Data

(71) Applicants: Hakhyun Nam, Daejeon (KR); Heesung Woo, Daejeon (KR); Hyuncheol Jeong, Daejeon (KR); Inho Song, Bucheon (KR); Changhyoung Ryu, Daejeon (KR)

(72) Inventors: Hakhyun Nam, Daejeon (KR); Heesung Woo, Daejeon (KR); Hyuncheol Jeong, Daejeon (KR); Inho Song, Bucheon (KR); Changhyoung Ryu, Daejeon (KR)

(21) Appl. No.: 13/276,092

(22) Filed: Oct. 18, 2011

(30) Foreign Application Priority Data
Sep. 28, 2011 (KR) 10-2011-0098463

(51) Int. Cl. G06T 1/00

(52) U.S. Cl. 345/522

(57) ABSTRACT

Disclosed are an image data display system and a method for displaying image data. A user just inputs the portable storage medium 600 into the DID main board 200 without using any input device, the update process can be automatically executed according to the contents of the “update” folder and “delete.txt” file of the portable storage medium. Also, the image data display system can immediately display corresponding image file matching with a scanned product code, when the user scans the product code by using the code scanner.

### CROSS-REFERENCE TO RELATED APPLICATION

This application claims priority from Korean Patent Application No. 10-2011-0098463, filed on Sep. 28, 2011, in the Korean Intellectual Property Office, the disclosure of which is incorporated herein by reference in its entirety.

### BACKGROUND

1. Field of the Invention

The present invention is related to an image data display system and a method for displaying image data, more particularly to an image data display system and a method for displaying image data, which can execute the updating process for image files without using an input device separately, and immediately display an image file matching to a product code scanned by a user during displaying an image file with predetermined order.

2. Description of the Related Art

In general, a monitor displays an image data provided from a graphic card of a computer system to watch and see the video and audio signals.

A CRT monitor was used in early beginning time, and these monitors have been developing continuously such as CRT monitor, LCD (Liquid Crystal Display) monitor, LED (Light Emitting Diode) monitor, and PDP (Plasma Display Panel) monitor etc.

Accordingly, the general monitor is connected to a personal computer to display the contents stored in the personal computer, and these monitors are widely applied various fields such as a management monitor, an outdoor advertising monitor, an indoor advertising monitor, and an information display monitor, etc.

In particular, a monitor system is installed in a PC and operated to display image files for promoting various products. For example, the first prior art of KR Utility Model No. 20-2008-0004669 discloses an advertising LCD monitor including a displaying part, installed in front and center of a main body, for displaying image data, a logo part of a certain company installed onto the upper part of the displaying part, and a pair of product parts installed on both left side and right side of the displaying part, respectively.

Thus, the advertising LCD monitor displays the additional information including a company advertisement, weather, time, and etc. onto the pair of product parts installed in the left and right sides in real time base during displaying a certain image data.

However, the advertising LCD monitor should be constituted of the complicated configuration, since the advertising LCD monitor displays the image data and the company advertisement on the pair of product parts at the same time.

Also, if a user wants to newly store or delete a certain image data in the display part or product part, or to immediately display the desired image data, the user should operate the necessary control process by using the input device.

Also, the second prior art of KR Laid-Open Publication No. 10-2008-0066479 discloses an advertising monitor having image display decoder including a storage medium, an input part, an image and voice decoder for decoding the image data read in the storage medium, an LCD panel for displaying the image data decoded by the image and voice decoder, and a speaker installed in a body.

However, the advertising monitor is constituted of necessary circuits for reproducing advertising image data, the constitution was more simple relatively than the computer terminal of the first prior art.

Meanwhile the user wants to display, store, or delete the image data, the user should also operate the input device of the advertising monitor.

Also, the third prior art of KR Laid-Open Publication No. 10-2008-0071726 discloses an advertising monitor which can be controlled by a user. The advertising monitor does not constitute an input part in comparison with the constitution of the advertising monitor of the second prior art.

However, a user wants to display, store, or delete a certain image data, the user should operate an infrared light remote controller or a remote controlling part by using the infrared light communication of a cellular phone in a wireless data part for establishing the wireless data network to remotely control the advertising monitor.

However, the user wants to display, store, or delete the image data, the user should also operate the infrared light remote controller or the cellular phone.

As described three prior arts, the user wants to newly store, or delete the image data in predetermined order, or immediately display the image data, the user should operate, the user should operate the input device or the wireless input device of the monitor system to execute the desired controlling operation.

However, in case that the monitor is installed in the indoor stores such as department stores, outdoors, or indoor place so that people can look the monitor in outdoor, a monitor manager can require to newly store, delete, or display image data without operating any input device depending on their needs.

For example, a monitor manager want to display the image data corresponding to the purchasing product to promote the products without operating any input device as consulting the purchase with a customer, the manager must be used a wired or wireless input device to operate the desired operation with the prior monitor system.

In addition, this operation is required the separated time with concentration to perform the operation.

If the manager can display the image data corresponding to the purchasing product without operating any input device as consulting the purchase with the customer, the customer can have confidence in the product likely to lead to the purchase.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

This invention has been invented to solve the aforementioned problem. Therefore, the object of this invention is to provide an image data display system and a method for displaying image data, which can automatically execute update process of deleting, storing, or displaying certain image data by only inserting a portable storage medium into the image data display system.

Also, the other object of this invention is to provide an image data display system and a method for displaying image data, which can immediately display corresponding image data matching with a scanned product code, which is adhered or printed onto a product, and is scanned by using a code scanner, during displaying one or more image data by a predetermined order.

Also, the another object of this invention is to provide an image data display system and a method for displaying image data, which can show the total scanned number of times on a certain edge of the monitor by counting and accumulating each scanned number of times per each product code during a predetermined period, as the corresponding image data is displaying in the monitor.

To achieve these objects and other advantages and in accordance with the purpose of the invention, as embodied and broadly described herein, an image data display system comprises a case formed with inner space for exhibiting sample products; a DID (Digital Information Displayer) main board, installed inside the case, for reading image file by a predetermined order and outputting decoded image data; an external memory, attachably connected with the DID main board, for storing at least one image file read out by controlling of a user; a monitor, mounted in front of the case, for displaying audio and video signals outputted from the DID main board; a code scanner, attachably connected with the DID main board, for scanning a product code and providing the scanned code to the DID main board; a portable storage medium, attachably connected with the DID main board, for storing a deletion list to delete corresponding image file stored in the external memory and newly storing the image file in the external memory;

wherein, the user inserts the portable storage medium into the DID main board, the DID main board automatically delete at least one image file stored in the external memory according to the deletion list inputted in the portable storage medium, and copies at least one image file stored in the portable storage medium and stores the image file in the external memory.

In another aspect of the present invention, a method of displaying an image data in an image data displaying system having a DID (Digital Information Displayer) main board, installed inside the case, for reading image file by a predetermined order and outputting decoded image data, and an external memory, attachably connected with the DID main board, for storing at least one or more image file read out by controlling of a user, the method comprising the steps of: (a1) creating and storing at least one image file, which will be newly stored in a portable storage medium, and inputting at least one file name of an image file to delete from at least one image file stored in the external memory; (b1) inserting the portable storage medium into the DID main board; (c1) deleting corresponding image file by the DID main board, if at least one deleting image file is exist; and (d1) automatically copying and storing at least one image file in the external memory by the DID main board, if at least one image file, which will be newly stored in the external memory, is exist.

In other aspect of the present invention, A method of displaying an image data in an image data displaying system having a DID (Digital Information Displayer) main board, installed inside the case, for reading image file by a predetermined order and outputting decoded image data, an external memory, attachably connected with the DID main board, for storing at least one or more image file read out by controlling of a user, and a monitor for displaying audio and video signals outputted from DID main board, the method comprising the steps of: (a2) storing at least one image file designating with the same file name as an identification number of a certain product code in the external memory connected to the DID main board; (b2) attachably connecting the external memory to the DID main board; (c2) automatically displaying at least one or more image file stored in the external memory in a predetermined order by the DID main board; (d2) scanning a product code of a certain product by using a code scanner which is attachably connected to DID main board; and (e2) interrupting corresponding image file presently displaying when the scanned product code is inputted, and immediately displaying an image file designated with the same file name as an identification number of a certain product code among at least one image file stored in the external memory.

### BRIEF DESCRIPTION OF THE DRAWING FIGURES

The above and/or other aspects will be more apparent by describing in detail exemplary embodiments, with reference to the accompanying drawings, in which:

FIG. 1 is an outside view of an image data display system of according to an exemplary embodiment of the present invention.

FIG. 2 is a block diagram of an image data display system of according to an exemplary embodiment of the present invention.

FIG. 3 is a block diagram of a DID main board of an image data display system of according to an exemplary embodiment of the present invention.

FIG. 4 is a software block diagram applying in an image data display system of according to an exemplary embodiment of the present invention.

FIG. 5 is a flowchart of an initialization process of an image data display method of according to an exemplary embodiment of the present invention.

FIG. 6 is a flowchart of an image data automatic repetition display process of an image data display method of according to an exemplary embodiment of the present invention.

FIG. 7 is a flowchart of an update process of an image data display method of according to an exemplary embodiment of the present invention.

FIG. 8 is a flowchart of a code interlinked display process of an image data display method of according to an exemplary embodiment of the present invention.

### DETAILED DESCRIPTION OF THE EXEMPLARY EMBODIMENTS

Hereinafter, the present invention will be described in greater detail with reference to the accompanying drawings.

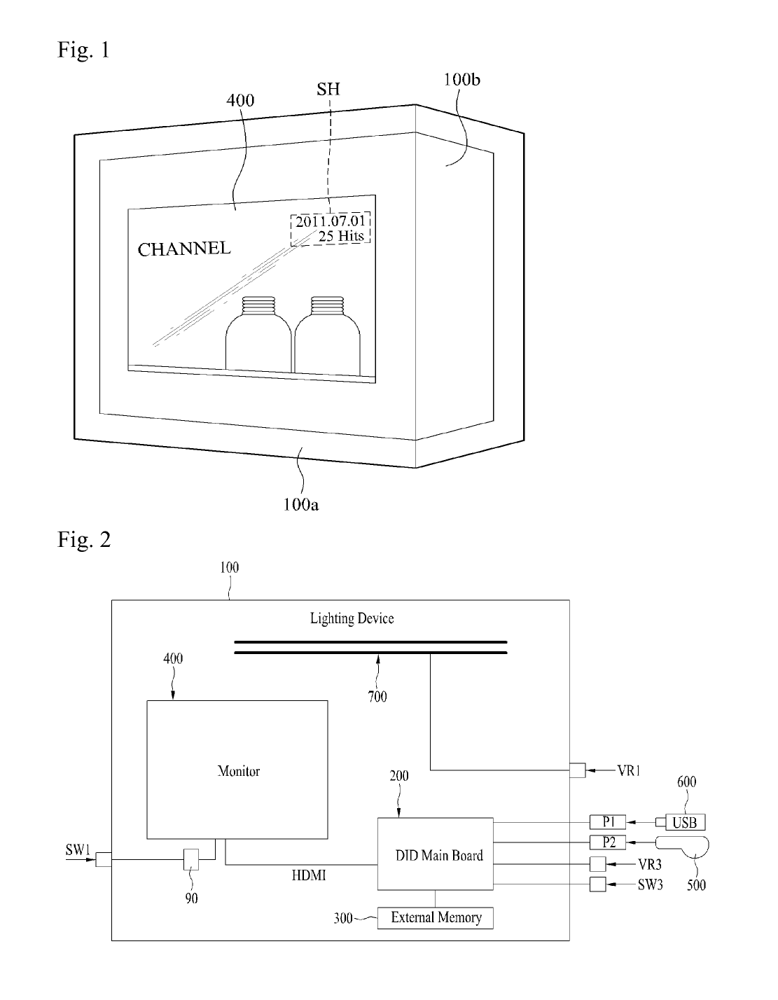

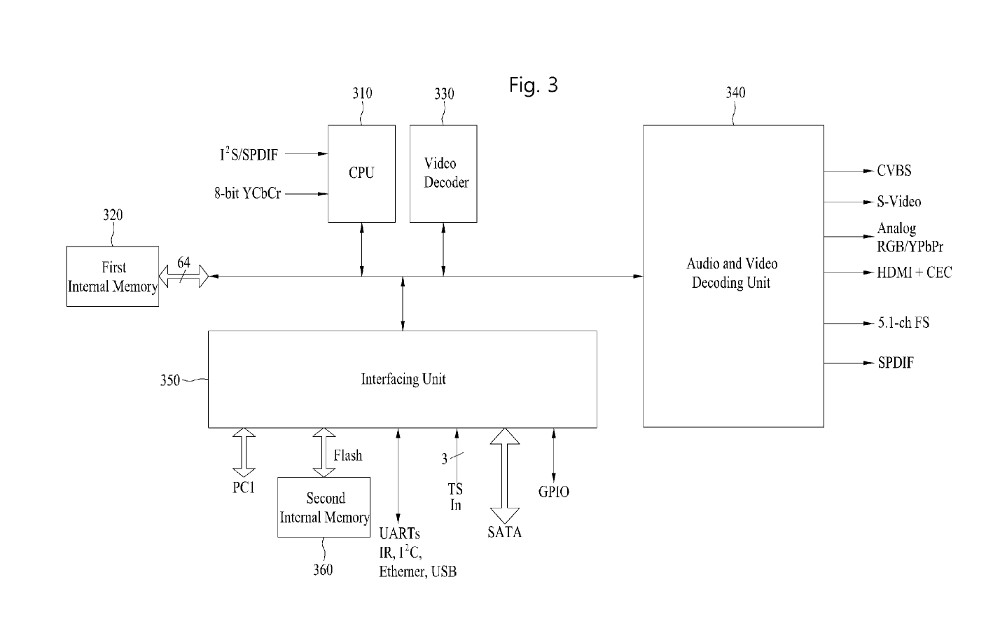

FIG. 1 is an outside view of an image data display system of according to an exemplary embodiment of the present invention, and FIG. 2 is a block diagram of an image data display system of according to an exemplary embodiment of the present invention.

Referring to FIGS. 1 and 2, an image data display system includes a square case 100 formed with inner space for exhibiting sample products; a DID (Digital Information Displayer) main board 200, installed inside the square case 100, for reading one or more image file by a predetermined order and outputting decoded image file to view and hear at all users; an external memory 300, attachably connected with the DID main board 200 and having a database engine for managing the total scanned number of times of scanning a certain product code during a predetermined period, for storing one or more image file read out by controlling of a user; a monitor 400, mounted in front of the square case 100, for displaying audio and video signals outputted from the DID main board 200; a code scanner 500, attachably connected with the DID main board 200, for scanning a bar code or RFID code of a certain product and providing the scanned data to the DID main board; a portable storage medium 600, attachably connected with the DID main board 200, for storing deletion list to delete one or more image file stored in the external memory 300 and storing the image file in the external memory 300; and a lighting device 700 for emitting light in the inner space of the square case 100.

The external memory 300 can be used among CF, ND, MD, CD, DVD, SDHC, SDXC memory, or SATA HDD memory as a available storage medium for storing image files by connecting with the DID main board 200, and it is desirable to use a SD card in the preferred embodiment of the present invention.

Also, the monitor 400 is selected from a CRT monitor, an LCD monitor, an LED monitor, and a PDP monitor, and it is desirable to use a transparent monitor in the preferred embodiment of the present invention.

Also, the code scanner 500 is selected from a bar code scanner or RFID (Radio Frequency Identification) scanner.

In general, the bar code is adhered or printed onto the outer surface of a product, a wrapping paper, or a package, and is selected among one-dimension linear bar code of EAN-13 CODE, CODE 39, 2/5 CODE, CODE 128, and two-dimension linear bar code of QR (Quick Response) code, stacked Bar Code, and matrix bar code.

Also, it is desirable that the portable storage medium 600 is an USB memory, and the lighting device 700 is used by selecting various LED back light device for emitting light.

In FIG. 2, a control switch VR1, installed in the square case 100, is to control the illumination of the LED light, an adapter 90 is to rectify the AC power with the predetermined voltage level, and a power switch SW1, installed in the square case 100, is to control the driving of the monitor 400.

Also, a volume control switch VR3, installed in the square case 100, is to control the sound volume of a speaker, and a power switch SW3 is to control the power on/off of the DID main board 200.

FIG. 3 is a block diagram of the DID main board of an image file display system of according to an exemplary embodiment of the present invention.

Referring to FIG. 3, the DID main board 200 includes a central processing unit (CPU) 310 for controlling other elements or devices, and decoding and executing the program order to display the image data stored in the external memory 300 onto the monitor 400; a first internal memory (DDR-2 DRAM) 320 for loading the image file read out the external memory by controlling the CPU 310; a video decoder 330 for decoding the image data read out the external memory 300 by using an own built-in hardware codec; an audio and video output section 340 for forwarding the decoded image data mixed with text data; an interfacing section 350 for reading out the image file stored in the portable storage medium 600 and loading the image file in the first internal memory 320 by using one of PCI, USB, SATA interface; and a second internal memory (flash memory) 320 including a boot loader for initializing each hardware mounted on Linux system, and Kernel for executing soft initialization to operate the Linux system.

It is desirable that the interfacing section 350 is selected among Component interface or D-Subminiature interface which can provide HD image data by using the analog technique, or High-Definition Multimedia Interface (HDMI) for providing the digital audio and video data through one cable at the same time.

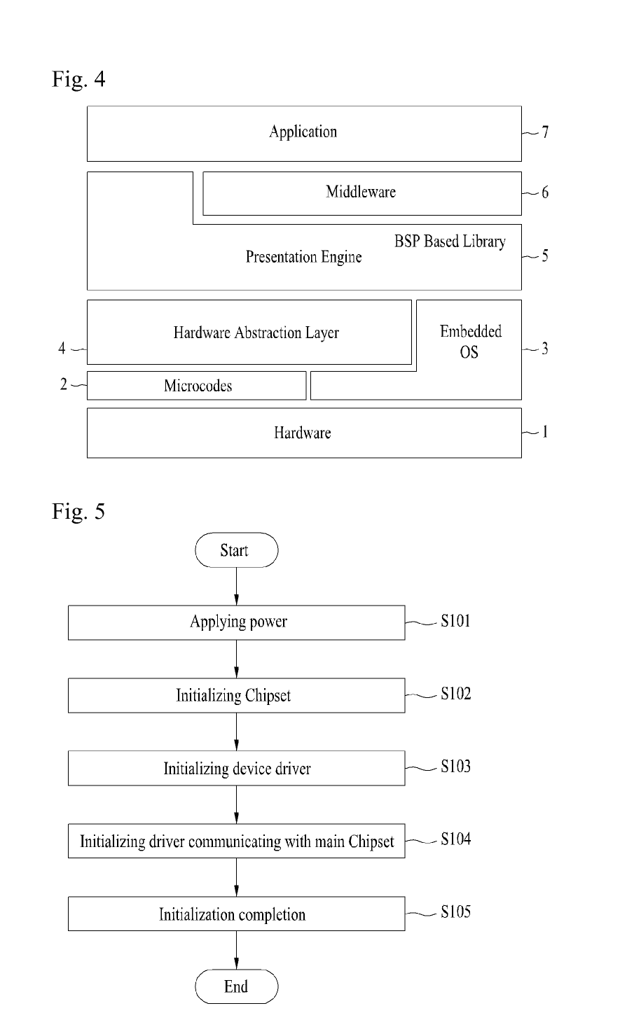

FIG. 4 is a software block diagram applying in the image data display system of according to an exemplary embodiment of the present invention.

Referring to FIG. 4, a hardware layer 1, called as a physical layer, is a physical constitution for constituting a media player including a main chipset and other devices.

A microcodes layer 2 is a high rank language than a machine code, and is used to directly control the hardware with a commend level, and the microcodes layer 2 is used to initialize the video decoder 330 through the security code related in a license in the preferred embodiment of the present invention.

An embedded OS layer 3 is an operating system of a hardware flatform and it is desirable to be mounted and applied with Embedded Linux 2.6.x in the preferred embodiment of the present invention.

A hardware abstraction layer 4 is a interface for communicating with the hardware through a device driver in the operating system.

A presentation engine layer 5 is a software module (i.e, service layer) realized by a parameter designation format to reproduce and control various media such as the image and voice data of the different codec.

A middleware layer 6 is a soft package for effectively managing the signal and data inputted by a user and various input and output devices which is not served in the built-in chipset, and realizing UI/UX (User Interface/User Experience) which is familiar to all users.

It is desirable that Direct FB is used as the middleware layer 6 after porting program to meet the image data display system of the present invention.

An application layer 7 is a software which is developed to meet a certain purpose by using one of UI/UX, HID (Human Interface Device), Storage I/O Interface.

A monitor output message and an image file update process, for managing the image data display system based on bar code or RFID code recognition, are executed by the application program based on the Direct FB Middleware.

FIG. 5 is a flowchart of an initialization process of the image data display method of according to an exemplary embodiment of the present invention.

Referring to FIGS. 2 through 5, a user applies the electric power to the DID main board 200 and the monitor 400 by controlling the power switches SW1 and SW3, respectively (S101).

The CPU 310 initializes a chipset of the DID main board 200 by using the boot loader stored in the second internal memory 360 and loads Embedded Linux Kernel stored in the second internal memory 360 (S102).

Next, if the Embedded Linux Kernel is installed into the first internal memory 320, the device driver, connected with the Kernel to use each interface device installed in the image data display system, is initialized (S103).

Next, the CPU 310 initializes a driver to communicate with the main chipset by using shell script stored in the external memory 300 (S104).

At this stage, the Direct FB middleware library, used in preceding the final application program, is loaded through the shell script stored in the external memory 300, and then the initialization setting process of the image data display system is completed (S105).

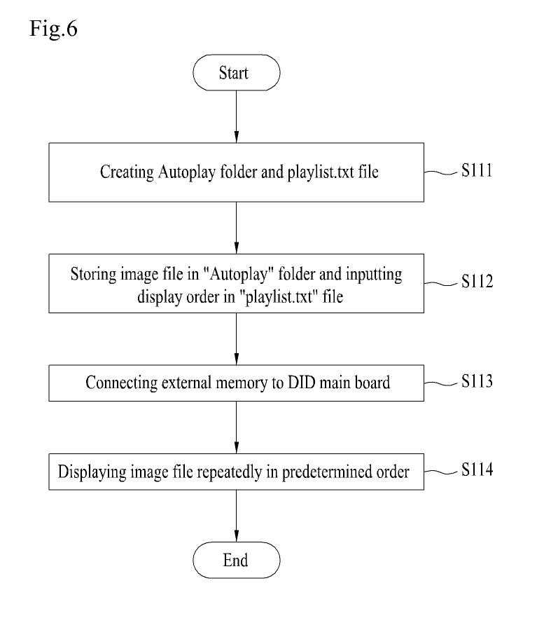

FIG. 6 is a flowchart of the image data automatic repetition display process of the image data display method of according to an exemplary embodiment of the present invention.

Referring to FIG. 6, in case that the initialization process is completed, the user attachably connects the external memory in a personal computer and formats the external memory by using FAT 32 file system, and creates “Autoplay” folder and “playlist.txt” file selectively in the external memory 300, respectively (S111).

Here, the “Autoplay” folder is used to store one or more image file which will be displayed in the monitor 400, and the “playlist.txt” file is used to input a display order for the image file stored in the external memory 300.

Next, the user stores one or more image file in the “Autoplay” folder of the external memory 300 and inputs one or more image file name on the “playlist.txt” file according to a predetermined order (S112).

Here, the user attachably connects the external memory 300, stored the image file for displaying in the monitor 400 and the play list for designating display order, onto a connecting terminal of the DID main board 200 (S113).

Accordingly, the CPU 310 displays one or more image file stored in the external memory 300 according to the predetermined order (S114).

Here, if the user does not input the display list in the “playlist.txt” file, the CPU 310 repeatedly displays the stored image files stored in the external memory 300 according to alphabet order.

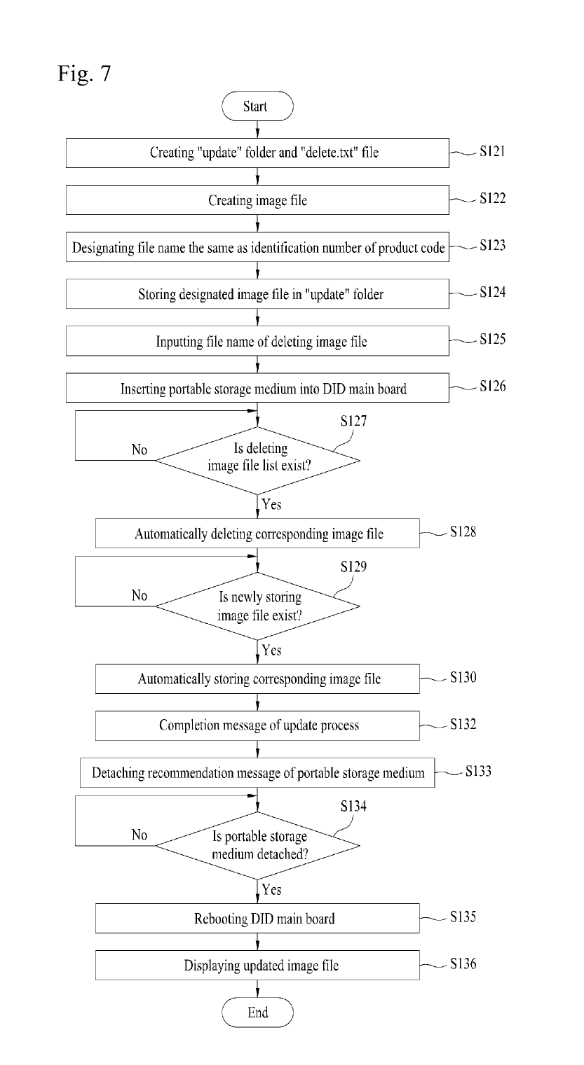

FIG. 7 is a flowchart of an update process of the image file display method of according to an exemplary embodiment of the present invention.

Referring to FIG. 7, the user connects the portable storage medium 600 such as the USB memory to the personal computer and formats the portable storage medium 600 by using FAT32 file system, and creates an “update” folder and a “delete.txt” file in the portable storage medium 600, respectively (S121).

Here, the “update” folder is used to store image files for displaying onto the monitor, and automatically copies and stores the stored image files in the external memory 300, while the “delete.txt” file is used to input a delete list of the image file stored in the external memory 300.

Next, the user creates one or more image file for displaying onto the monitor 400 by using the personal computer in the “update” folder of the portable storage medium 600 (S122).

Next, the user designates one or more file names of the created image file the same as an identification number of bar code or the RFID code (S123), and then copies the image file and stores the copied image file in the “update” folder of the portable storage medium 600.

At this time, if one or more deleting image file is exist in the external memory 300, the user inputs the file name of image file in the “delete.txt file of the portable storage medium 600 (S125).

For example, the user designates the file name of four image files stored in the “update” folder of the portable storage medium 600 as 8801037032581.wmv 8801069222479.avi 8809003500447.mpg 8809005588429.mp4 respectively, each file name means each identification number of the bar code or RFID code of the product.

Meanwhile, if the user inputs 4 file names of 8801037032581.wmv 8801069222479.avi 8809003500447.mpg 8809005588429.mp4 in the “delete.txt” file of the portable storage medium 600 respectively, each file name means each identification number of the bar code or RFID code of the product.

At this stage, the user can inputs “none” after [delete] in the “delete.txt” file coded in automatic executing delete program, in case the deleting image file is not exist. But, the user can inputs “all” after [delete] in the “delete.txt” file coded with automatic executing delete program, in case all image files will be deleted.

Next, the user separates the portable storage medium 600 from the personal computer, and inserts the portable storage medium 600 into one of two USB terminals P1 and P2 of the DID main board 200 to be electrically connected (S126).

Then, if the CPU 310 of the DID main board 200 detects that the portable storage medium 600 is inputted, the CPU 310 judges whether the deletion list of the image file is exist or not in the “delete.txt” file of the portable storage medium 600 (S127).

As a result of the judgment 5127, if the deletion list of the image file is exist in the “delete.txt” file of the DID main board, the CPU 310 of the DID main board 200 deletes the corresponding image file (S128).

Next, the CPU 310 of the DID main board 200 judges whether one or more image file is exist or not to newly store in the “update” folder of the portable storage medium 600 (S129).

As a result of the judgment 5129, if the image file is exist in the “update” folder of the DID main board, the DID main board 200 copies the corresponding image file stored in the portable storage medium 600 and stores the corresponding image file in the external memory 300 (S130).

Next, the DID main board 200 displays a message for notifying the update process completion onto the monitor 400 (S132), and then displays onto the monitor 400 a message for recommending to detach the portable storage medium 600 which is inserted the USB terminal P1 of the DID main board 200 (S133).

Then, the CPU 310 of the DID main board 200 judges whether the portable storage medium 600 is detached or not (S134).

As a result of the judgment 5134, the portable storage medium 600 is detached, the DID main board 200 judges that all update process is completed, and reboots the DID main board 200 to make an index of all image files as newly updated image file (S135).

Accordingly, the DID main board 200 displays the image files updated in the external memory 300 according to the predetermined order (S136).

As above described in FIG. 7, the user just inputs the portable storage medium 600 into the DID main board 200 without using any input device, the update process including deleting operation or newly storing operation can be automatically executed according to the contents of the “update” folder and “delete.txt” file of the portable storage medium 600.

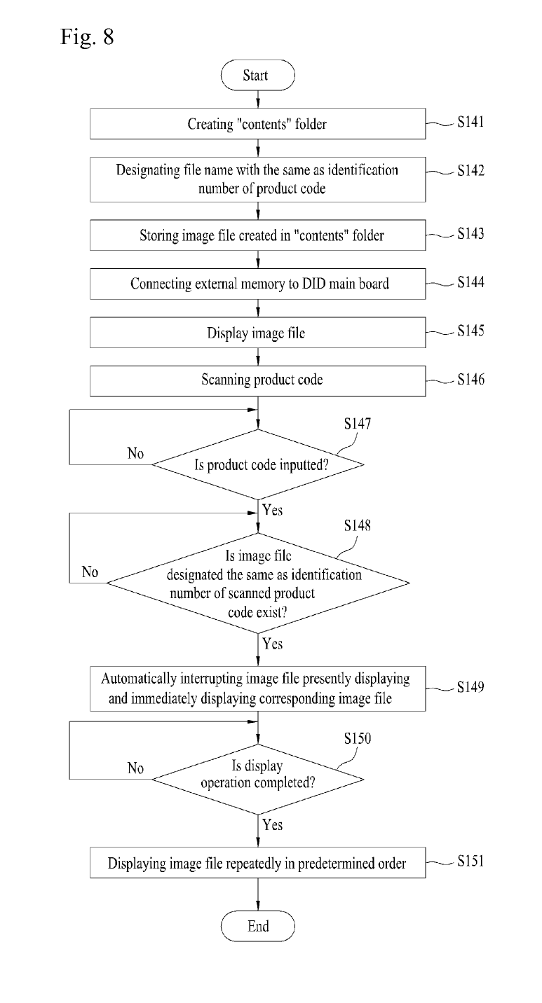

FIG. 8 is a flowchart of a code interlinked display process of the image data display method of according to an exemplary embodiment of the present invention.

Referring to FIG. 8, the user connects the external memory 300 to a personal computer in the condition that the initialization process is completed, the user creates “contents” folder in the external memory 300 (S141).

Next, the user creates one or more image file to display onto the monitor 400 and designates each file name of the image file the same as an identification number of a bar code or a RFID code of a certain product by using the personal computer (S142).

Next, the user copies the image file designated with the identification number of the bar code or the RFID code and created in the personal computer, and stores the image file in the “contents” folder of the external memory 300 (S143).

Next, the user attachably connects the external memory 300 to a connecting terminal of the DID main board 200 (S144).

The CPU 310 of the DID main board 200 displays one or more image file stored in the “contents” folder of the external memory 300 by a predetermined order (S145).

Meanwhile, the user can scan the bar code or the RFID code by using the code scanner 500, in case that the code scanner 500 is attachably connected with other USB terminal P2 of the DID main board 200 (S146).

The CPU 310 of the DID main board 200 judges whether the bar code or the RFID code is inputted or not (S147).

As a result of the judgment 5147, if the bar code or the RFID code is inputted, the CPU 310 of the DID main board 200 judges whether one or more image file designated with the same an identification number of the bar code or the RFID code of the product is exist or not in the “contents” folder of the external memory 300 (S148).

As a result of the judgment 5148, if one or more image file designated with the same as the identification number of the bar code or the RFID code of the product is exist, the CPU 310 of the DID main board 200 immediately interrupts the image file presently displaying in the monitor 400, and then immediately displays the corresponding image file designated the same as the identification number of the bar code or the RFID code of the product (S149).

Also, the CPU 310 of the DID main board 200 judges whether the image file presently displaying in the monitor 400 is completed or not (S150).

As a result of the judgment 5150, the current display is completed, the DID main board 200 continuously displays the image file interrupted for a while by scanning operation of the user (S151).

In case of S146 scanning step, whenever the user scans the bar code or the RFID code of the product, the DID main board 200 displays the total scanned number of times during a predetermined period (e.g. hour, day, week, month etc.) for matching the scanned bar code or RFID code, as displaying the corresponding image file for matching the scanned code is displayed in the monitor 400.

Thus, the DID main board 200 counts each scanned number of times whenever the user scans the bar code or the RFID code by using the embedded database engine stored in the external memory 300.

At this time, the database engine can manage the product code, when the bar code or the RFID code is detected one time, as shown in table 1.

TABLE 1

| | |
|---|---|
| NO | increasing in due order, and check the scanned number |
| | of times of the product code |
| KEY | identification number of product code |
| DATETIME | product code created date |

Accordingly, the database engine can record and manage that how many time the same bar code or the RFID code of the product are scanned by the code scanner during the predetermined period, whenever the user scans the same bar code or the RFID code as shown in table 2.

TABLE 2

| | |
|---|---|
| KEY | identification number of each product |
| HIT | increasing by 1 as scanned by the user, check the total |
| | scanned number of the times |

Also, the scanned data and time for each product code can be managed as shown in table 3.

TABLE 3

| | |
|---|---|
| KEY | identification code of product code |
| DATETIME | stored in scanned date respectively, whenever |
| | scanned by date |

Accordingly, customers can see the total scanned number of the times (SH) for the product code during the predetermined period on the monitor 400, and can assume the purchase tendency of other people as shown in FIG. 1.

As above described in FIG. 8, the image data display system can immediately display corresponding image file matching with a scanned product code, when the user scans the product code by using the code scanner.

Thus, the user can consult with the customer for the certain product and immediately display the image file corresponding to the same product by only scanning the product code without using any input device, and thereby maximizing the promotion effect for the same product.

Although a preferred embodiment of the present invention has been illustrated and described, those skilled in the art will appreciate that various changes may be made to the preferred embodiment of the present invention without departing from the technical spirit and scope of the present invention.

Accordingly, various modifications are possible unless they deviate from the gist of the present invention recited in the appended claims. Such modifications should not be construed individually from the technical idea or prospect of the present invention.

What is claimed is:

1. An image data display system comprises:
a case formed with inner space for exhibiting sample products;
a DID (Digital Information Displayer) main board, installed inside the case, for reading image file by a predetermined order and outputting decoded image data;
an external memory, attachably connected with the DID main board, for storing at least one image file read out by controlling of a user;
a monitor, mounted in front of the case, for displaying audio and video signals outputted from the DID main board;
a code scanner, attachably connected with the DID main board, for scanning a product code and providing the scanned code to the DID main board;
a portable storage medium, attachably connected with the DID main board, for storing a deletion list to delete corresponding image file stored in the external memory and newly storing the image file in the external memory;
wherein, the user inserts the portable storage medium into the DID main board, the DID main board automatically delete at least one image file stored in the external memory according to the deletion list inputted in the portable storage medium, and copies at least one image file stored in the portable storage medium and stores the image file in the external memory.

2. The image data display system according to claim 1, wherein if the user scans a product code by the code scanner in case of displaying an image file stored in the external memory in a predetermined order, the DID main board immediately interrupts the display of the image file currently displaying in the monitor, and then immediately display an image file designated the same as an identification number of a certain product code among at least one image file stored in the external memory.

3. The image data display system according to claim 2, wherein the DID main board displays the total scanned number of times scanned the same product code during a predetermined period, whenever the user scans the product code by using the code scanner.

4. The image data display system according to claim 1, wherein the external memory is selected from CF, ND, MD, CD, DVD, SD, SDHC, or SDXC memory, SATA HDD memory.

5. The image data display system according to claim 1, wherein the product code is a bar code or a RFID code, and the code scanner is a bar code scanner or a RFID code scanner.

6. The image data display system according to claim 1, wherein the portable storage medium is an USB memory.

7. The image data display system according to claim 1, wherein the DID main board comprising:
a central processing unit (CPU) for controlling other elements or devices, and decoding and executing the program order to display the image data stored in the external memory onto the monitor;
a first internal memory for loading the image file read out the external memory by controlling the CPU;
a video decoder for decoding the image data read out the external memory by using an own built-in hardware codec;
an audio and video output section for forwarding the decoded image data mixed with text data;
an interfacing section for reading out the image file stored in the portable storage medium and loading the image file in the first internal memory; and
a second internal memory including a boot loader for initializing each hardware mounted on Linux system, and Kernel for executing soft initialization to operate the Linux system.

8. A method of displaying an image data in an image data displaying system having a DID (Digital Information Displayer) main board, installed inside the case, for reading image file by a predetermined order and outputting decoded image data, and an external memory, attachably connected with the DID main board, for storing at least one or more image file read out by controlling of a user, the method comprising the steps of:
(a1) creating and storing at least one image file, which will be newly stored in a portable storage medium, and inputting at least one file name of an image file to delete from at least one image file stored in the external memory;
(b1) inserting the portable storage medium into the DID main board;
(c1) deleting corresponding image file by the DID main board, if at least one deleting image file is exist; and
(d1) automatically copying and storing at least one image file in the external memory by the DID main board, if at least one image file, which will be newly stored in the external memory, is exist.

9. The method of displaying the image data according to claim 8, wherein the creating, storing and inputting step (a1) comprising the sub-steps of:
creating an “update” folder and a “delete.txt” file in the portable storage medium in a personal computer, respectively;
creating at least one image file in the personal computer;
designating the created image file with the same file name an identification number of a certain product code, and copying and storing the image file in the “update” folder of the portable storage medium; and
inputting the file name of at least one deleting image file in the “delete.txt” file of the portable storage medium.

10. The method of displaying the image data according to claim 9, wherein the deleting step (c1) comprising the sub-steps of:
judging whether an image file list, which will be deleted, is exist or not in the “delete.txt” file of the portable storage medium, when the DID main board detects that the portable storage medium is inserted; and
automatically deleting corresponding image file stored in the external memory by the DID main board, if the deleting image file is exist.

11. The method of displaying the image data according to claim 10, wherein the deleting step is executed by inputting corresponding command in a next line of [delete] in a program automatically executing in the “delete.txt” file.

12. The method of displaying the image data according to claim 11, wherein the corresponding commend is selected from “none” for not existing at least one deleting image file, “all” for deleting all image files, or each file name.

13. The method of displaying the image data according to claim 8, wherein the copying and storing step (d1) comprising the sub-steps of:
judging whether at least one image file, which will be newly stored, is exist or not in the “update” folder of the portable storage medium; and
automatically copying and storing the corresponding image file in the external memory, if the storing image file is exist.

14. The method of displaying the image data according to claim 8, wherein the product code is a bar code or a RFID code, and the code scanner is a bar code scanner or a RFID code scanner.

15. A method of displaying an image data in an image data displaying system having a DID (Digital Information Displayer) main board, installed inside the case, for reading image file by a predetermined order and outputting decoded image data, an external memory, attachably connected with the DID main board, for storing at least one or more image file read out by controlling of a user, and a monitor for displaying audio and video signals outputted from DID main board, the method comprising the steps of:
(a2) storing at least one image file designating with the same file name as an identification number of a certain product code in the external memory connected to the DID main board;
(b2) attachably connecting the external memory to the DID main board;
(c2) automatically displaying at least one or more image file stored in the external memory in a predetermined order by the DID main board;
(d2) scanning a product code of a certain product by using a code scanner which is attachably connected to DID main board; and
(e2) interrupting corresponding image file presently displaying when the scanned product code is inputted, and immediately displaying an image file designated with the same file name as an identification number of a certain product code among at least one image file stored in the external memory.

16. The method of displaying the image data according to claim 15, wherein the storing step (a2) comprising the sub-steps of:
creating a “contents” folder in the external memory in a personal computer;
creating at least one image file designating with the same file name as the identification number of the product code in the personal computer;
copying the created image file and storing the copied image file in the “contents” folder of the external memory.

17. The method of displaying the image data according to claim 15, wherein the interrupting and displaying steps (e2) comprising the sub-steps of:
judging whether the scanned product code is inputted or not by the DID main board;
judging whether the image file, designated with the same file name as the identification number of the product code, is exist or not in the “contents” folder, if the scanned product code is inputted; and
automatically interrupting the image file presently displaying and immediately displaying an image file designating with the same file name as the identification number of the product code among at least one image file stored in the external memory, if the image file, designating with the same file name as the identification number of the product code, is exist.

18. The method of displaying the image data according to claim 15, wherein the DID main board displays the total scanned number of times scanned the same product code during a predetermined period, whenever the user scans the product code by using the code scanner.

19. The method of displaying the image data according to claim 15, wherein the product code is a bar code or a RFID code, and the code scanner is a bar code scanner or a RFID code scanner.

20. The method of displaying the image data according to claim 15, wherein the portable storage medium is an USB memory.
